(19) United States
(12) Patent Application Publication
(10) Pub. No.: US 2009/0017434 A1
(43) Pub. Date: Jan. 15, 2009

(54) Method And System Of Computerized Examination Strategy Analyzer

(76) Inventor: Dror Avigdor, Kiryat Motzkin (IL)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 12/172,351

(22) Filed: Jul. 14, 2008

Related U.S. Application Data
(60) Provisional application No. 60/959,154, filed on Jul. 12, 2007.

(51) Int. Cl. G09B 7/00

(52) U.S. Cl. 434/362

(57) ABSTRACT

The invention presents a computerized strategy analyzer of multiple-choice tests. The analyzer analyses user behavior during tests and simulated tests and provides feedback of different kinds including recommendations on how to distribute time during a test and what type of questions need further study.

### FIELD OF THE INVENTION

The present invention relates to examination analysis. More particularly, the present invention relates to computerized method and system strategy analysis of multiple-choice tests. The method analyses user behavior during tests and simulated tests and provides feedback of different kinds.

This present invention claims the benefit of earlier U.S. provisional patent application Ser. No. 60/959,154 filed on 12 Jul. 2007 by Dror Avigdor and entitled “Computerized examination strategy analyzer”.

### BACKGROUND OF THE INVENTION

Multiple-choice examinations are most common around the world, when it comes to entering academic education in many countries around the world. Examples of such exams are the Psychometric exam in Israel, SAT and ACT in the United States. There are many more time-limited multiple-choice examinations. Since one's performance in those exams might have a critical influence on his future, most students spend a lot of time and great amounts of money to be prepared for these exams.

The inventor of the present invention developed the computerized analyzer through extremely wide experience of dealing with multiple-choice examinations and preparing thousands of students towards those examinations.

### SUMMARY OF THE INVENTION

It is an object of the present invention to provide an effective computerized examination strategy analyzer for students adapted to be used for improving their chances of succeeding and obtaining better results in multiple-choice examinations.

It is another object of the present invention to provide a computerized examination strategy analyzer that provides the student with the possibility to take advantage of a well experienced teacher by using a very accurate method. The system measures different timing parameters during tests and simulated tests and provides different types of recommendations on how to mange the exam or test.

It is yet another object of the present invention to provide the students with very specific and detailed feedback from the computerized analyzer regarding techniques by which they may obtain better results.

It is thus provided in accordance with a preferred embodiment of the present invention A method for training and testing a trainee to take multi-choice and/or time bound exams comprising:

executing at least one test;

collecting data during the test;

analyzing the collected data and generating results;

applying recommendation rules based on the generated results and history data to generate recommendations.

Furthermore and in accordance with another preferred embodiment of the present invention, the test is a simulation or comprehensive exam such as ACT, TOFEL, GRE, GMAT or any plurality of sections in such exams.

Furthermore and in accordance with another preferred embodiment of the present invention, the collected data describe the trainee's behavior and include details such as time spent on each question/section and how many times each question was viewed.

Furthermore and in accordance with another preferred embodiment of the present invention, the collected data describe the results achieved by the trainee.

Furthermore and in accordance with another preferred embodiment of the present invention, the generated results include information such as statistics on correct/wrong answers, type of questions that make trainee spend longer period of time.

Furthermore and in accordance with another preferred embodiment of the present invention, the generated recommendations include recommendations such as: take a short practice before the exam, balance time spent on each question by adding more time to different questions, sped only the recommended time period in each question, watch for over time spending on questions, need further practice in some type of questions, interleave working on unseen questions with other questions.

It is also provided in accordance with another preferred embodiment of the present invention a system for training a trainee or taking a test of multi-choice and/or time bound exams comprising:

a computer capable of executing test;

data collector for gathering data during the test and generating collected data;

analyzer for applying analysis on the collected data and history data for generating recommendations;

wherein a trainee takes a test or simulated test, during the test, data is collected on trainee's behavior and results achieved, the collected data is analyzed by the analyzer to generate recommendations on proper strategies for taking future and current tests.

Furthermore and in accordance with another preferred embodiment of the present invention, the test is a simulation or a comprehensive exam such as ACT, TOFEL, GRE, GMAT or any plurality of sections in such exams.

Furthermore and in accordance with another preferred embodiment of the present invention, the data collector gathers data during the test and the gathered data describe the trainee's behavior and include details such as, time spent on each question/section, how many times each question was viewed.

Furthermore and in accordance with another preferred embodiment of the present invention, the data collector gathers data during the simulation and the gathered data describe the results achieved by the trainee (e.g., answer correct/wrong).

Furthermore and in accordance with another preferred embodiment of the present invention, the data collector also generates collected data that include information such as statistics on correct/wrong answers, type of questions that make trainee spend longer period of time.

In addition and in accordance with another preferred embodiment of the present invention, the analyzer apply analysis on the collected data and history data for generating recommendations that include recommendations such as: take a short practice before the exam, or balance time spent on each question by adding more time to different questions, sped only the recommended time period in each question, watch for over time spending on questions, need further practice in some type of questions, interleave working on unseen questions with other questions.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a system for executing a computerized examination strategy analyzer in accordance with a preferred embodiment of the present.

FIG. 2 illustrates a block diagram of a method of using computerized examination strategy analyzer, in accordance with a preferred embodiment of the present invention.

FIG. 3 illustrates three recommendation rules, concerning timing issue, applied by the computerized examination strategy analyzer in accordance with a preferred embodiment of the present invention.

FIG. 4 illustrates three recommendation rules, concerning answering results, applied by the computerized examination strategy analyzer in accordance with a preferred embodiment of the present invention.

### DESCRIPTION OF PREFERRED EMBODIMENTS

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing.

The computerized analyzer of the present invention can be implemented in two different fields of activity.

In a first field in accordance to one aspect of the present invention, a main feature of the computerized examination strategy analyzer is analyzing the trainee's strategy by which he is taking the test. According to the inventor, if it was possible for him as a teacher, to observe each and every student in his class for exactly 100 percent of the time during a simulation exam, without taking his eyes off of him, while documenting accurately each and every observation-based comment such as when he was too hasty, too hesitant, when he was too slow, and diagnosing accurately the student's weak spots and strong ones and many other important parameters—he would be happy to do so for his students. However, this is an impossible task for any teacher. It is unattainable to perform such activity even for one simulation exam, and one student, even. Moreover, each student takes at least 5-6 simulation exams during the days before the actual exam, and a teacher usually handles 20-30 students in each class. Furthermore, some highly mathematical skilled students in some cases do not reach all the questions during the mathematical section. In some cases, they even do not get the chance to meet some easy questions at the end of the section, which they could solve easily and quickly. An effective diagnose may provide the students the correct feedback and help them go through more questions without the need to extend the period of time they have for the section. In this way, the examinee reaches all the questions, and has a better chance to fill out more correct answers. In addition to the direct influence on the final results, the examinee is encouraged by his success to perform even better on the other sections as well. The implementation of the method of the present invention may increase the performance of the users in dozens of percentage.

The computerized analyzer of the present invention monitors and processes the trainee's behavior during the test, records the time in which he is answering each question and each field, the amount of guesses, the trainee's concentration during the different parts of the test, the trainee's orientation in each field and each section of the test, the type of question that cause the examinee decrease in concentration, the amount of times the examinee returned to each question, and the trainee's way of filling in the answers sheet. The technological measured to monitor the examinee behavior is achieved by at least one counter wherein each counter is adapted to measure a different parameter, at least one timer adapted to be activated and halted simultaneously for several diagnosis wherein the timers are controlled by the software, a documentation algorithm for the user input in the answer's sheet. In addition, it can be provided several user-input controls preferably presented as forms during the examination and machine indicators for capturing users operations such as opening sketch for viewing, opening “formula sheet” for viewing etc.

Any other means that are adapted to perform the same operations or other operation that provides information regarding additional parameters are covered by the scope of the present invention.

The computerized analyzer presents textual feedback and recommendations for the next test or simulated test, it presents numerical summary according the fields and sections of the exam in a very clear and user friendly manner.

In addition to the specific feedback for each and every test and simulated test, the computerized analyzer analyzes the results of a series of simulations taken by the student. The analyzer provides a clear view on the performance in past exams and recommendations for improvements. It also provides predictions on the possibility of obtaining a certain level of success. Such information is needed in order to evaluate the option of being accepted to a university or postponed application to a later time and further preparing to get better score. The use of the computerized analyzer saves time and money and would be beneficial for the examinee.

In a second field, in accordance to another aspect of the present invention, a main feature of the computerized examination strategy analyzer is analyzing the trainee's strategy by which he is taking the test.

Achieving outstanding results in multi-choices and time restricted exams is not easily done, despite the fact that the technical learning materials are not complicated. Most of the questions are easily solved by most high school students. The gap between the level of the exam and the average results is explained by other characteristics of the exams: time pressure, outsized amount of short questions that do not allow the examinee to take a few seconds break from thinking, length of the exams, the difficulty in maintaining high concentration level for a long period of time, the difficulty to adjust the exam conditions during the first times the examinee takes them, the distracters located in the answers and many other typically hardening factors.

In yet another aspect of the present invention the computerized analyzer acts as a simulator for the examinee in several exams. The analyzer is adapted to facilitate the examinee to adjust to the hardening factors and allows him to compete mainly with the technical learning material. The simulation is being performed in an exact manner as the real examination; the examinee cannot go through the sections, unless the time allows it (according to limited time), it limits the examinee according with the exact time, it prints out a matching answers sheet, it prints out a page with the specific questions that requires drawing and sketching, and during the exam it alerts the examinee 5 minutes before he runs out of time.

It should be noted that the analyzer preferably presents analyzing results include textual, numerical, summary as well as recommendations and conclusions.

In order to implement each of the aspects of the present invention, the user can optionally work on a personal computer onto which software of the analyzer is installed or work on a PC that is connected, through some communication network possible an internet, to a server on which the analyzer software is installed. The provider of the analyzer software can choose whether the analyzer is downloaded to the PC's or kept on a server without the ability to manipulate the software. In any case, the results from the analysis can be processed and stored onto the PC of the user or on the server.

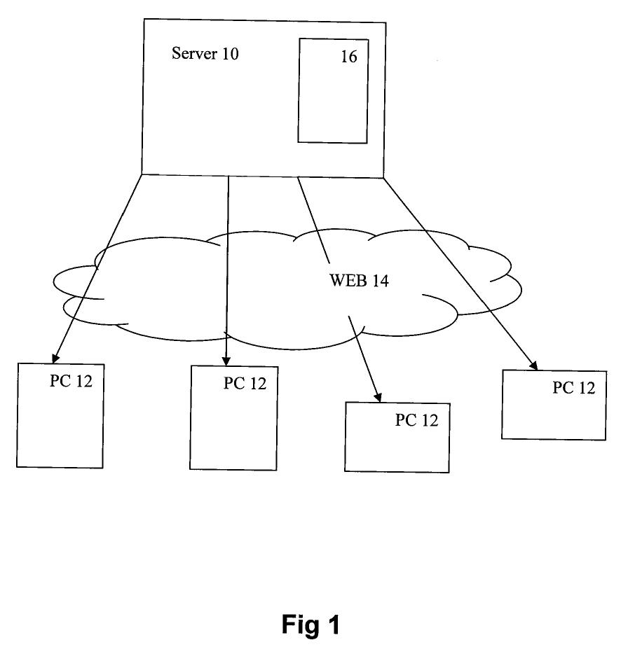

Reference is now made to FIG. 1 illustrating a system for a computerized examination strategy analyzer in accordance with a preferred embodiment of the present invention. Server 10 is provided with analyzer dedicated software 16. Plurality of users can work on their own PC computers 12 through a web 14 such as an internet and to download examinations to be filled in. Analyzer's software 16 using the tools that are provided (as mentioned herein before) is adapted to collect information from the examination and the manner in which the user fills the forms and to analyze the performance of the user as explained.

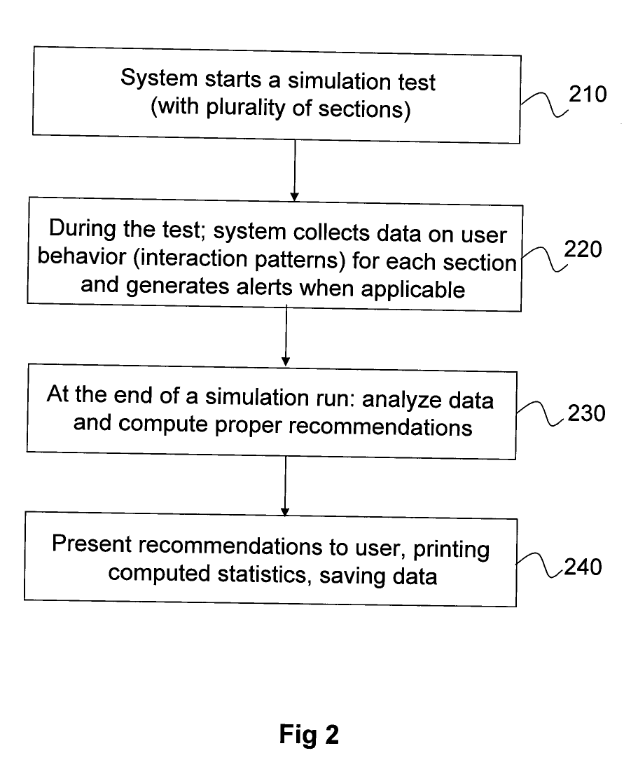

Reference is now made to FIG. 2 illustrating a block diagram of a method of using computerized examination strategy analyzer in accordance with a preferred embodiment of the present invention. The system keeps records of previous simulations (history) and for plurality of users. From an optional welcome screen the system recognize the user (optional usemame and password are used). A simulation run can be initiated by a user as many times as needed.

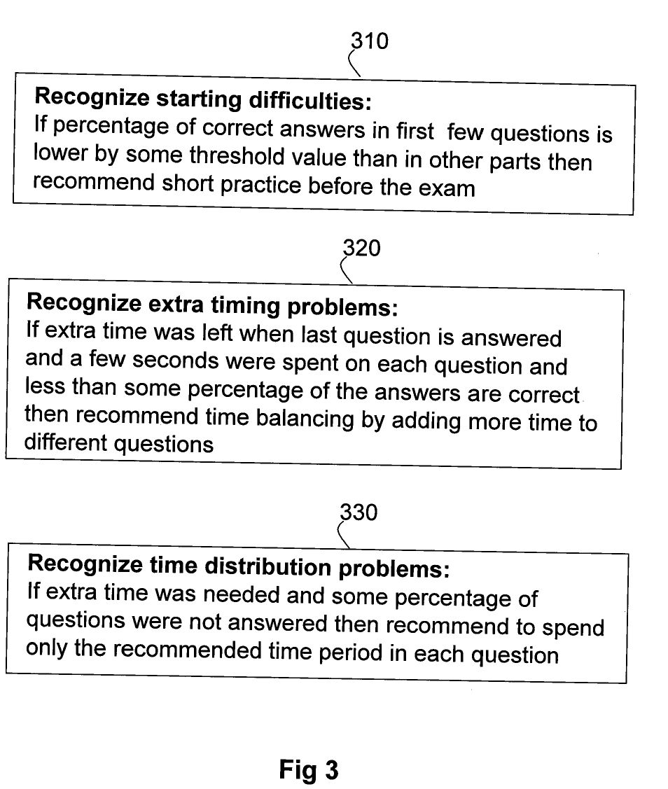

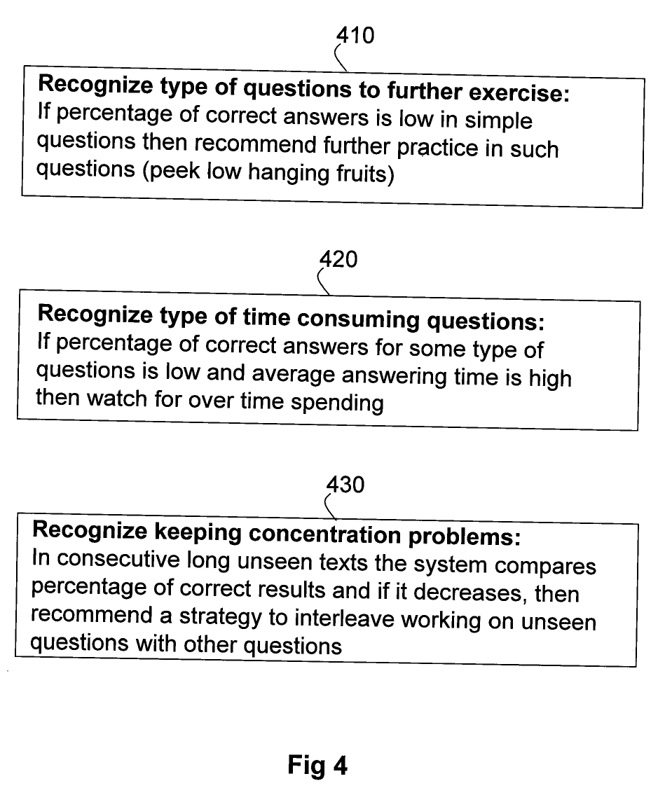

FIG. 2 represent the method for a single test and simulation run. In Step 210, the system starts a test or a simulated test (with plurality of sections) and prints out any attached page necessary for the exam, e.g., pages for questions that requires sketching, printing and presenting an answer sheet. During test, Step 220, the system collects data on the user behavior, such as, how long he spent on each question section, how many times he viewed each question (going forward and backward), is the answer to a question correct; the system may generates alerts such as five minute to the end of the exam, next, at the end of a test or a simulation run of Step 230 the system applies analysis to newly collected and history data, computes proper recommendations and present them to the user, computes different statistics such as average time per type of questions, show test results, show answers and detailed solutions to questions, show summary of collected data like the type of questions that make trainee spend longer period of time, and save information for future use, Step 240. Generating the recommendation can describe by a set of rules and conditions that are parts of the analyzer, examples of such recommendation rules are described in FIGS. 3 and 4. The above simulation can be repeated for each section and for each test. It should be noted that other rules can be applied without limiting the scope of the present invention.

Reference is now made to FIGS. 3 and 4 illustrating six recommendation rules applied by the computerized examination strategy analyzer in accordance with a preferred embodiment of the present invention. The rules can be further exemplified by instantiating them for analyzing trainee behavior during a psychometric examination in Israel and producing recommendations for the trainee.

The examples are based on the Psychometric exam taken in Israel. Each exam has its own set of conclusions and recommendations for the examinee after taking the simulation exams preferably supplied with the analyzer. As an example, for a specific Psychometric exam taken in Israel, there are 62 possible conclusions for the examinee. He's main target should be implementing those conclusions and recommendations. Implementing the recommendation produces major improvement in the final results. For understanding of these few examples, one should know the structure of the Psychometric exam.

The exam is consisted of three types of sections: Mathematical, English and Hebrew. There are two sections of each type, and two more sections of random types of the three. For example, the exam can include three mathematical sections, three English sections and two Hebrew sections—a total of eight sections. Each type of section includes 3 to 15 types of questions. Types can be, for example algebra, geometry, restatements, reading comprehension etc. For this example, the recommendation rules are instantiated with the values seen bellow.

Rule 310 is instantiated as follows:

Recognize starting difficulties: If percentage, preferable more than half, of correct answers in first few, preferable 5, questions is lower by some threshold value, preferable 50% or more, than in other parts then recommend short practice before the exam, preferable solve 10-15 questions prior to exam.

Rule 320 is instantiated as follows:

Recognize extra timing problems: If extra time was left when last question is answered, preferable 5 minutes, and a few seconds were spent on each question, preferable at least 8 seconds, and less than some percentage, preferable 80, of the answers are correct, then recommend time balancing by adding more time to different questions.

Rule 330 is instantiated as follows:

Recognize time distribution problems: If extra time was needed and some percentage, preferable 80%, of questions were not answered then recommend to spend only the recommended time period in each question.

Rule 410 is instantiated as follows:

Recognize type of questions to further exercise: If percentage of correct answers is low, preferable 67% or less, in simple questions then recommend further practice in such questions (peek low hanging fruits).

Rule 420 is instantiated as follows:

Recognize type of time consuming questions: If percentage, preferable 50%, of correct answers for some type of questions is low and average answering time is high then watch for over time spending.

Rule 430 is instantiated as follows:

Recognize keeping concentration problems: In consecutive long unseen texts the system compares percentage of correct results and if it decreases, preferable by 51%, then recommends a strategy to interleave working on unseen questions with other questions.

1. A method for training and testing a trainee to take multi-choice and/or time bound exams comprising:
executing at least one test;
collecting data during the test;
analyzing the collected data and generating results;
applying recommendation rules based on the generated results and history data to generate recommendations.

2. The method as claimed in claim 1, wherein the test is a simulation or comprehensive exam such as ACT, TOFEL, GRE, GMAT or any plurality of sections in such exams.

3. The method as claimed in claim 1, wherein the collected data describe the trainee's behavior and include details such as time spent on each question/section and how many times each question was viewed.

4. The method as claimed in claim 1, wherein the collected data describe the results achieved by the trainee.

5. The method as claimed in claim 1, wherein the generated results include information such as statistics on correct/wrong answers, type of questions that make trainee spend longer period of time.

6. The method as claimed in claim 1, wherein the generated recommendations include recommendations such as: take a short practice before the exam, balance time spent on each question by adding more time to different questions, sped only the recommended time period in each question, watch for over time spending on questions, need further practice in some type of questions, interleave working on unseen questions with other questions.

7. A system for training a trainee or taking a test of multi-choice and/or time bound exams comprising:
a computer capable of executing test;
data collector for gathering data during the test and generating collected data;
analyzer for applying analysis on the collected data and history data for generating recommendations;
wherein a trainee takes a test or simulated test, during the test, data is collected on trainee's behavior and results achieved, the collected data is analyzed by the analyzer to generate recommendations on proper strategies for taking future and current tests.

8. The system as claimed in claim 7, wherein the test is a simulation or a comprehensive exam such as ACT, TOFEL, GRE, GMAT or any plurality of sections in such exams.

9. The system as claimed in claim 7, wherein the data collector gathers data during the test and the gathered data describe the trainee's behavior and include details such as, time spent on each question/section, how many times each question was viewed.

10. The system as claimed in claim 7, wherein the data collector gathers data during the simulation and the gathered data describe the results achieved by the trainee (e.g., answer correct/wrong).

11. The system as claimed in claim 7, wherein the data collector also generates collected data that include information such as statistics on correct/wrong answers, type of questions that make trainee spend longer period of time.

12. The system as claimed in claim 7, wherein the analyzer apply analysis on the collected data and history data for generating recommendations that include recommendations such as: take a short practice before the exam, or balance time spent on each question by adding more time to different questions, sped only the recommended time period in each question, watch for over time spending on questions, need further practice in some type of questions, interleave working on unseen questions with other questions.
